(19) United States
(12) Patent Application Publication
(10) Pub. No.: US 2014/0022241 A1
(43) Pub. Date: Jan. 23, 2014

(54) DISPLAY APPARATUS AND METHOD BASED ON SYMMETRICALLY SPB

(71) Applicant: Electronics and Telecommunications Research Institute, Daejeon-si (KR)

(72) Inventors: Hyun LEE, Daejeon-si (KR); Eung Don LEE, Daejeon-si (KR)

(21) Appl. No.: 13/940,408

(22) Filed: Jul. 12, 2013

(30) Foreign Application Priority Data
Jul. 18, 2012 (KR) 10-2012-0078357
Jul. 3, 2013 (KR) 10-2013-0077501

(51) Int. Cl. G02B 27/22; G09G 3/36

(52) U.S. Cl. CPC G02B 27/2214; G09G 3/36
USPC 345/419; 349/15

(57) ABSTRACT

Provided are a display apparatus and method based on an SSPB. The display apparatus includes a panel configured to play a 3-D image, a parallax barrier configured to include liquid crystals placed in the front of the panel and configured to transmit or block light emitted from the panel and pairs of transparent electrodes obliquely arranged to cross each other in a symmetric form in the front and rear of the liquid crystals based on the liquid crystals, and a driving unit configured to apply driving voltages to the parallax barrier. The parallax barrier can transmit or block a specific part of the played 3-D image through the panel in response to the applied driving voltages.

Priority to Korean patent application number 10-2012-0078357 filed on Jul. 18, 2012 and number 10-2013-0077501 filed on Jul. 3, 2013 the entire disclosure of which is incorporated by reference herein, is claimed.

### BACKGROUND OF THE INVENTION

1. Field of the Invention

Embodiments of the present invention relate to a parallax stereogram and, more particularly, to an autostereoscopic 3-Dimensional (3-D) display apparatus and method for displaying a 3-D image using a parallax barrier.

2. Discussion of the Related Art

A 3-D display method is basically divided into a stereoscopic method in which a user needs to put on glasses when watching a 3-D image and an autostereoscopic method in which a user does not need to put on glasses when watching a 3-D image. The stereoscopic method can be classified into an anaglyph glasses method, a polarized glasses method, and a shutter classes method, and the autostereoscopic method can be classified into a lenticular method and a parallax barrier method.

The anaglyph stereoscopic method is a method of playing a 3-D image using a complementary color of red and blue. The anaglyph stereoscopic method is advantageous in that a complicated technique or expensive equipment is not necessary because an implementation principle is simple, but is disadvantageous in that it is difficult to precisely represent the color sense and vertigo is caused due to color separation.

The polarized stereoscopic method is a method of separating the scanning line of a display into even-numbered lines and odd-numbered lines and simultaneously playing a left picture and a right picture through the scanning lines. The polarized stereoscopic method is advantageous in that the structure of glasses is simple the glasses are cheap, but is disadvantageous in that resolution of a 3-D image is reduced because the scanning lines of a display are divided.

The shutter stereoscopic method is a method of alternately outputting a left picture and a right picture at rapid rate and is advantageous in that a reduction in the picture quality of a 3-D image can be minimized, but is disadvantageous in that an eye is rapidly strained and shutter glasses are expensive.

Meanwhile, the lenticular method of the autostereoscopic method is a method of disposing a lenticular lens in a display device. The lenticular method is advantageous in that glasses do not need to be worn when watching a 3-D image, but is disadvantageous in that a ripple pattern is seen when watching a 3-D image because a semi-circular lens is disposed in a display device and the display device is expensive.

In contrast, the parallax barrier method is a method of disposing a parallax barrier in a display device and is advantageous in that glasses do not need to be worn when watching a 3-D image, the fabrication of a display device is simple, and a ripple pattern is not seen when watching a 3-D image unlike the lenticular method. However, an autostereoscopic 3D display method based on a parallax barrier is disadvantageous in that a viewing angle is narrow because of the parallax barrier. Accordingly, there is a disadvantage in that a watching position must be fixed because a 3-D effect disappears when a viewing angle is changed.

As a technique for solving the problem, for example, Korean Patent Laid-Open Publication No. 10-2007-0023849 (Mar. 2, 2007) entitled “WIDE VIEWING ANGLE 3-D IMAGE DISPLAY DEVICE” discloses a Segmented Parallax Barrier (SPB) method of segmenting barrier electrodes into a plurality of fine barrier electrodes and providing a wide viewing angle by combining and driving the fine barrier electrodes depending on the location of a user. However, this method is disadvantageous in that crosstalk is generated because some of light penetrates a gap between the fine barrier electrodes, 3-D quality is deteriorated, a Flexible Printed Circuit (FPC) is expensive, and bonding becomes complicated.

Meanwhile, Korean Patent Laid-Open Publication No. 10-2012-0015259 (Feb. 21, 2012) entitled “IMAGE DISPLAY APPARATUS AND METHOD IN IMAGE SYSTEM” discloses control of a watching distance and viewing angle of an autostereoscopic 3-D display device by bonding multi-layered parallax barriers on an LCD panel and driving only barriers corresponding to a watching distance of a viewer, but turning off the remaining barriers. In this method, the multiple parallax barriers are necessary to continuously control the operation of the 3-D display device depending on a change in the position of a user. However, it is difficult to fabricate the multiple parallax barriers in its structure, and the multiple parallax barriers become a stumbling block to commercialization because a high cost is necessary for the multiple parallax barriers.

### SUMMARY OF THE INVENTION

An object of the present invention is to provide a display apparatus and method based on a Symmetric Segmented Parallax Barrier (SSPB), which can minimize production cost and also prevent crosstalk.

Another object of the present invention is to provide a display apparatus and method based on an SSPB, which can provide a smooth autostereoscopic type 3-D image depending on the location and watching distance of a user.

In accordance with an aspect of the present invention, a display apparatus based on parallax barrier includes a panel configured to play a 3-D image, a parallax barrier configured to include liquid crystals placed in the front of the panel and configured to transmit or block light emitted from the panel and pairs of transparent electrodes obliquely arranged to cross each other in a symmetric form in the front and rear of the liquid crystals based on the liquid crystals, and a driving unit configured to apply driving voltages to the parallax barrier, wherein the parallax barrier may transmit or block a specific part of the played 3-D image through the panel in response to the applied driving voltages.

As one embodiment, the transparent electrodes may include a plurality of patterned Indium Tin Oxides (ITOs), and the patterned ITOs included the pairs of transparent electrodes may be segmented into at least two groups.

As another embodiment, the wires for the transparent electrode may be distributed over the upper and lower layers of the liquid crystals.

As yet another embodiment, the liquid crystals may be Twisted Nematic (TN) liquid crystals.

As yet another embodiment, the driving unit may includes a plurality of electrodes for applying the driving voltages to the transparent electrodes and control the driving voltages applied to the transparent electrodes through the plurality of electrodes depending on a location and watching distance of a user.

As yet another embodiment, the parallax barrier may shift to a plurality of operating states depending on an arrangement of the driving voltages applied to the transparent electrodes.

In accordance with another aspect of the present invention, a parallax barrier may include liquid crystals placed between an upper substrate and a lower substrate and configured to transmit or block light and pairs of transparent electrodes obliquely arranged to cross each other in a symmetric form in the front and rear of the liquid crystals based on the liquid crystals, wherein the liquid crystals may transmit or block the light in response to driving voltages applied to the transparent electrodes.

In accordance with yet another aspect of the present invention, a method of a display apparatus based on a parallax barrier displaying a 3-D image includes playing a 3-D image and applying driving voltages to the parallax barrier depending on a location and watching distance of a user, wherein the parallax barrier may includes liquid crystals placed in the front of a panel for playing the 3-D image and configured to transmit or block light emitted from the panel and pairs of transparent electrodes obliquely arranged to cross each other in a symmetric form in the front and rear of the liquid crystals based on the liquid crystals.

### BRIEF DESCRIPTION OF THE DRAWINGS

FIG. 1 is a diagram showing a display structure using an existing SPB method;

FIG. 2 is a diagram showing a display structure using an existing DLPB method;

FIG. 3 is a diagram showing the structure of a display apparatus based on an SSPB with 3 states in accordance with an embodiment of the present invention;

FIG. 4 is a diagram showing the structure of a display apparatus based on an SSPB with 4 states in accordance with an embodiment of the present invention;

FIG. 5 is a diagram showing the operating states of an SSPB with 3 states in accordance with an embodiment of the present invention;

FIG. 6 is a diagram showing the operating states of an SSPB with 4 states in accordance with an embodiment of the present invention; and

FIG. 7 is a flowchart illustrating a display method based on an SSPB in accordance with an embodiment of the present invention.

### DETAILED DESCRIPTION OF THE EMBODIMENTS

Hereinafter, some embodiments of the present invention are described in detail with reference to the accompanying drawings in order for a person having ordinary skill in the art to which the present invention pertains to be able to readily implement the invention. It is to be noted the present invention may be implemented in various ways and is not limited to the following embodiments. Furthermore, in the drawings, parts not related to the present invention are omitted in order to clarify the present invention and the same or similar reference numerals are used to denote the same or similar elements.

In the entire specification, when it is said that one element ‘includes (or comprises)’ the other element, it means the one element may further include one or more other elements unless otherwise described. Furthermore, the term ‘ . . . unit’ described in the specification means a unit for processing at least one function or operation, and the unit may be implemented by hardware or software or a combination of hardware and software.

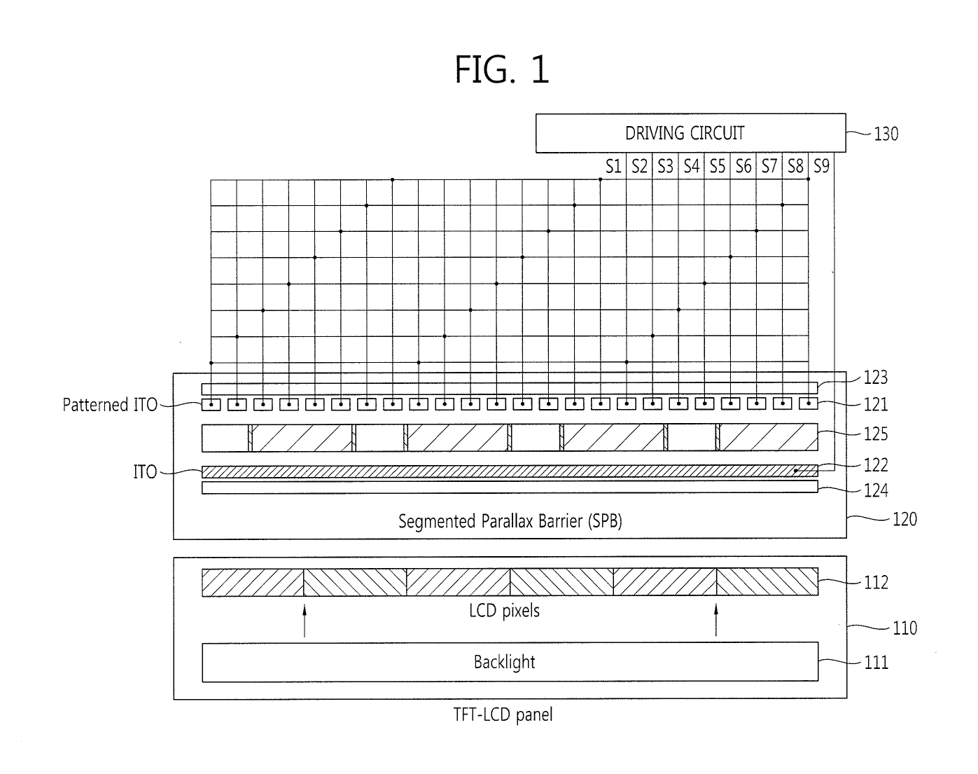

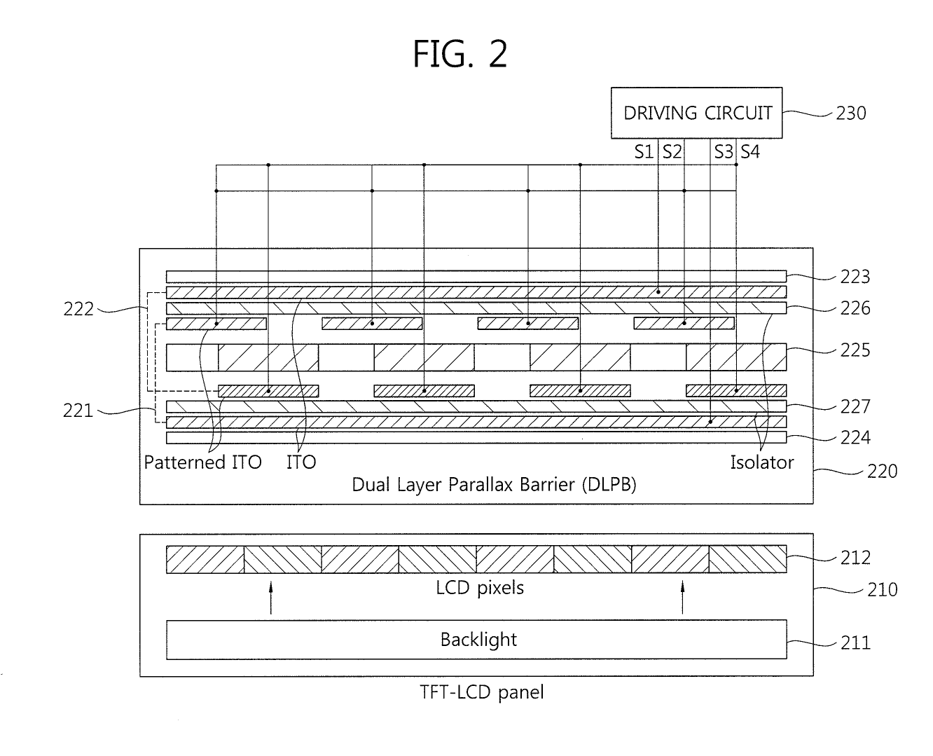

FIG. 1 is a diagram showing a display structure using an existing Segmented Parallax Barrier (SPB) method, and FIG. 2 is a diagram showing a display structure using an existing DLPB method.

Referring first to FIG. 1, the display device using an existing SPB method includes a Thin Film Transistor-Liquid Crystal Display (TFT-LCD) panel 110, an SPB 120, and a driving circuit 130.

The TFT-LCD panel 110 is a panel for playing an image by the pixel. As shown in FIG. 1, the TFT-LCD panel 110 basically includes a backlight 111 for emitting light and TFT liquid crystals 112 for playing LCD pixels by transmitting the light emitted from the backlight 111.

The SPB 120 includes a pair of transparent Indium Tin Oxide (ITO) electrodes 121 and 122, glass substrates 123 and 124, and Twisted Nematic (TN) liquid crystals 125. The transparent electrode 121 disposed between the upper glass substrates 123 and the TN liquid crystals 125 includes a plurality of fine barrier electrodes (i.e., patterned ITOs), as shown in FIG. 1.

When driving voltages are received, the SPB 120 separates light emitted from the TFT-LCD panel 110 so that the left and right eyes of a user transmit a left picture and a right picture. When a 3-D image is actually played, light emitted from the TFT-LCD panel 110 is blocked or transmitted by the TN liquid crystals 125 provided between the glass substrates 123 and 124. The TN liquid crystals 125 can be divided into a case where the TN liquid crystals 125 operate as normally black, that is, a method of the TN liquid crystals 125 transmitting light when a specific voltage is applied to the transparent electrode 121 and 122 (to the contrary, the TN liquid crystals 125 blocks light when a specific voltage is not applied to the transparent electrode 121 and 122), and a case where the TN liquid crystals 125 operate as normally white, that is, a method of the TN liquid crystals 125 transmitting light when a specific voltage is not applied to the transparent electrode 121 and 122 (to the contrary, the TN liquid crystals 125 blocks light when a specific voltage is applied to the transparent electrode 121 and 122), depending on a method of transmitting light.

In FIG. 1, for example, regions in which the liquid crystals transmit light are indicated by white, and regions in which the liquid crystals block light are indicated by oblique lines.

The driving circuit 130 is a circuit for providing the driving voltages to the SPB 120 and is coupled with the transparent electrodes 121 and 122 by a plurality of electrodes S1 to S9.

In an existing SPB method, such as that shown in FIG. 1, crosstalk is generated and thus 3-D quality can be deteriorated because some of light penetrates a gap between the fine barrier electrodes. Furthermore, the existing SPB method is disadvantageous in that it is difficult to wire the pair of transparent electrodes 121 and 122 because the pair of transparent electrodes 121 and 122 have an asymmetric structure in the parallax barrier.

Meanwhile, referring to FIG. 2, the display device using a Dual Layer Parallax Barrier (DLPB) method includes a TFT-LCD panel 210, a DLPB 220, and a driving circuit 230.

The TFT-LCD panel 210 includes a backlight 211 and TFT liquid crystals 212 for playing LCD pixels, like in the SPB method shown in FIG. 1.

The DLPB 220 includes a first parallax barrier layer 221, a second parallax barrier layer 222, glass substrates 223 and 224, and TN liquid crystals 225. As shown in FIG. 2, unlike in the SPB method, in the DLPB method, the two parallax barrier layers 221 and 222 formed of pairs of transparent electrodes (i.e., patterned ITOs and ITOs) are necessary and two-layered insulators 226 and 227 for preventing a short between the transparent electrode of the first parallax barrier layer 221 and the transparent electrode of the second parallax barrier layer 222 need to be inserted between the pairs of transparent electrodes. Accordingly, the thickness of the display apparatus is increased and it is difficult to fabricate the display apparatus.

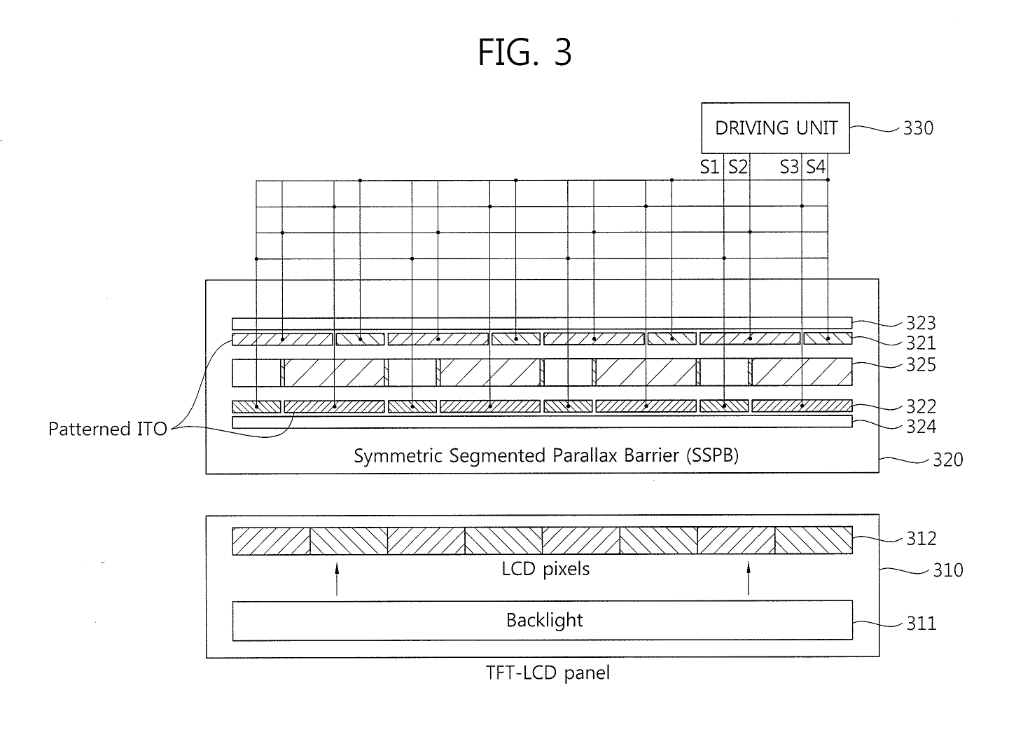

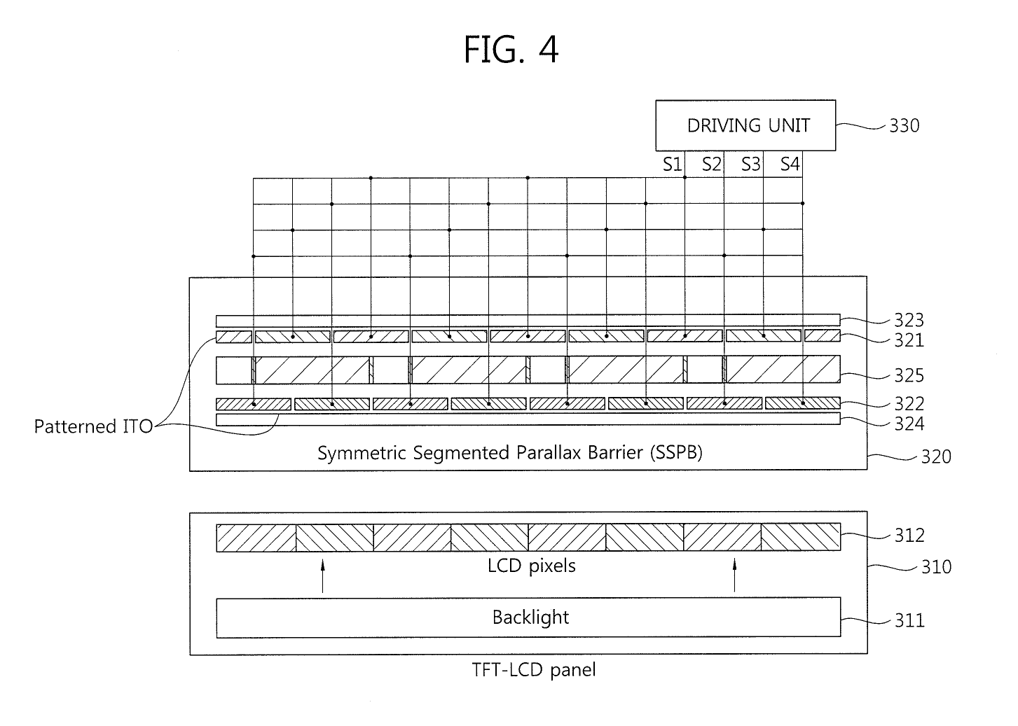

FIG. 3 is a diagram showing the structure of a display apparatus based on an SSPB with 3 states in accordance with an embodiment of the present invention, and FIG. 4 is a diagram showing the structure of a display apparatus based on an SSPB with 4 states in accordance with an embodiment of the present invention.

An autostereoscopic 3-D display device based on a Symmetric Segmented Parallax Barrier (SSPB) in accordance with the present invention can minimize production cost, prevent crosstalk, and provide a smooth autostereoscopic type 3-D image depending on a watching distance and location. To this end, the display apparatus based on an SSPB in accordance with the present invention can include a panel configured to play a 3-D image, a parallax barrier configured to include liquid crystals placed in the front of the panel and configured to transmit or block light emitted from the panel and pairs of transparent electrodes obliquely arranged to cross each other in a symmetric form in the front and rear of the liquid crystals on the basis of the liquid crystals, and a driving unit configured to apply driving voltages to the parallax barrier. Here, the parallax barrier can transmit or block a specific part of a played 3-D image through the panel in response to the applied driving voltages.

For example, the display apparatus based on an SSPB in accordance with the present invention can include a TFT-LCD panel 310, an SSPB 320, and a driving unit 330 as shown in FIGS. 3 and 4.

The TFT-LCD panel 310 can include a backlight 311 for emitting light and TFT liquid crystals 312 for displaying LCD pixels by transmitting the light emitted from the backlight 311. When playing a 3-D image, the TFT-LCD panel 310 can alternately display a left picture and a right picture by the column so that the left picture and the right picture are played at the same time.

The SSPB 320 can include pairs of transparent electrodes 321 and 322, an upper substrate 323, a lower substrate 324, and liquid crystals 325.

The pairs of transparent electrodes 321 and 322 are obliquely arranged to cross each other in a symmetric form between the upper substrate 323 and the liquid crystals 325 and between the lower substrate 324 and the liquid crystals 325, respectively, so that the liquid crystals 325 transmit or block light depending on an arrangement of driving voltages supplied from the driving unit 330 and thus light penetrated into the left and right eyes of a user can be separated. Here, the pairs of transparent electrodes 321 and 322 can include a plurality of patterned ITOs. Furthermore, the patterned ITOs included in the pairs of transparent electrode can be segmented into at least two groups. For example, FIGS. 3 and 4 illustrate that the patterned ITOs segmented into two groups on the basis of the liquid crystals 325 are obliquely arranged to cross each other in a symmetric form. As described above, in the SSPB 320 of the present invention, the wires of the transparent electrodes 321 and 322 can be distributed over the upper and lower layers of the liquid crystals 325 and the SSPB 320 can be easily manufactured because an insulator is not necessary because the pairs of transparent electrodes 321 and 322 have a symmetric structure.

The liquid crystals 325 are placed between the upper substrate 323 and the lower substrate 324 and are configured to transmit or block light in response to driving voltages applied to the pairs of transparent electrodes 321 and 322. For example, the upper substrate 323 and the lower substrate 324 can be glass substrates, and the liquid crystals 325 can be TN liquid crystals.

The driving unit 330 can include a plurality of electrodes for supplying the driving voltages to the transparent electrodes 321 and 322. Furthermore, the driving unit 330 can control the driving voltages, applied to the transparent electrodes 321 and 322, using the plurality of electrodes depending on a location and watching distance of a user. FIGS. 3 and 4 show an example in which the driving unit 330 supplies driving voltages to the transparent electrodes 321 and 332 using four electrodes S1 to S4.

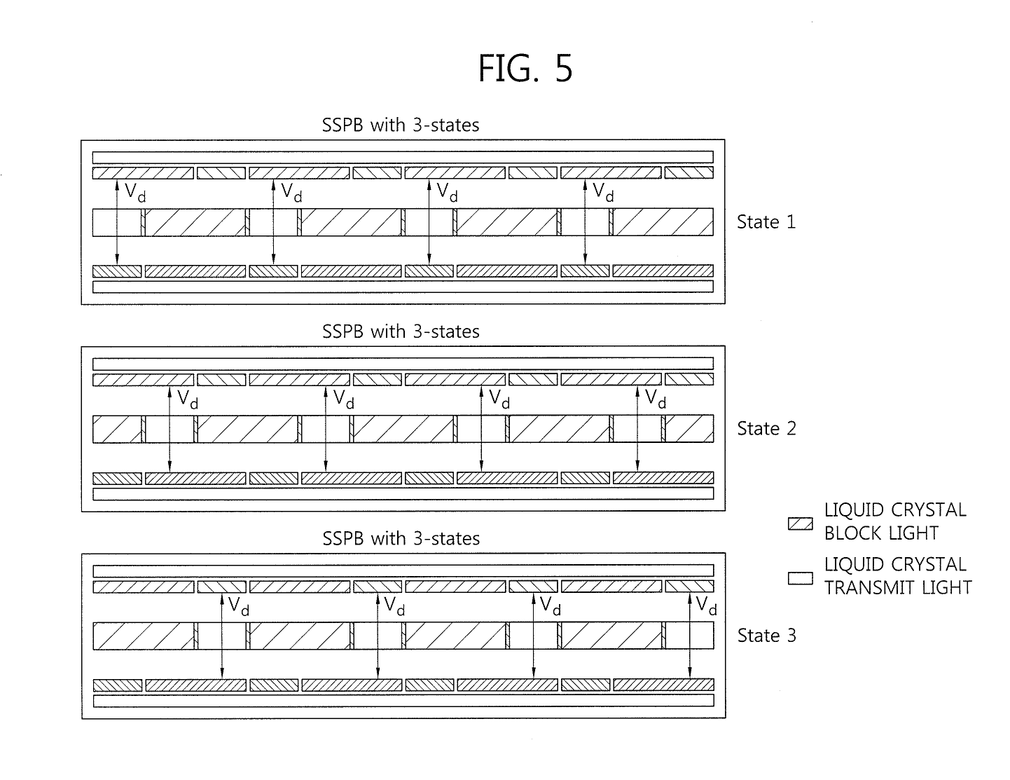

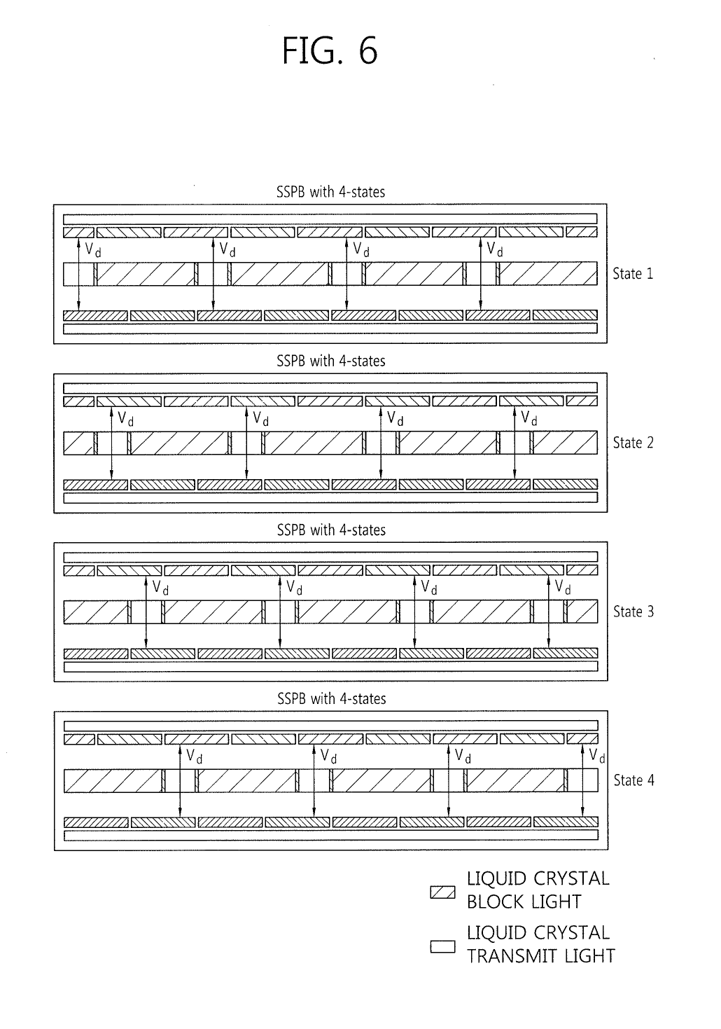

FIG. 5 is a diagram showing the operating states of the SSPB with 3 states in accordance with an embodiment of the present invention, and FIG. 6 is a diagram showing the operating states of the SSPB with 4 states in accordance with an embodiment of the present invention.

The SSPB of the present invention can shift to a plurality of operating states depending on an arrangement of the driving voltages applied to the transparent electrodes. FIGS. 5 and 6 show the shift of the operating states of the SSPB in accordance with the present invention when a method of the liquid crystals blocking light when voltage is not supplied (to the contrary, the liquid crystals transmit light when voltage is supplied) (i.e., normally black) is adopted.

As shown in FIG. 5, the SSPB with 3 states can operate in State 1 State 2, and State 3 as in Table 1 depending on an arrangement of the driving voltages applied to the transparent electrodes.

TABLE 1

| SSPB OPERATING STATE | OPERATION OF DRIVING UNIT |
|---|---|
| State 1 | S1-S2: apply driving voltage V_{d} |
| State 2 | S2-S3: apply driving voltage V_{d} |
| State 3 | S3-S4: apply driving voltage V_{d} |

State 1 can be formed when the driving voltage V_{d} is applied between the electrode S1 and the electrode S2. State 2 can be formed when the driving voltage V_{d} is applied between the electrode S2 and the electrode S3. State 3 can be formed when the driving voltage V_{d} is applied between the electrode S3 and the electrode S4.

Furthermore, as shown in FIG. 6, the SSPB with 4 states can operate in State 1 State 2, State 3, and State 4 as in Table 2 depending on an arrangement of the driving voltages applied to the transparent electrodes.

TABLE 2

| SSPB OPERATING STATE | OPERATION OF DRIVING UNIT |
|---|---|
| State 1 | S1-S2: apply driving voltage V_{d} |
| State 2 | S2-S3: apply driving voltage V_{d} |
| State 3 | S3-S4: apply driving voltage V_{d} |
| State 4 | S1-S4: apply driving voltage V_{d} |

State 1 can be formed when the driving voltage V_{d} is applied between the electrode S1 and the electrode S2. State 2 can be formed when the driving voltage V_{d} is applied between the electrode S2 and the electrode S3. State 3 can be formed when the driving voltage V_{d} is applied between the electrode S3 and the electrode S4. State 4 can be formed when the driving voltage V_{d} is applied between the electrode S1 and the electrode S4.

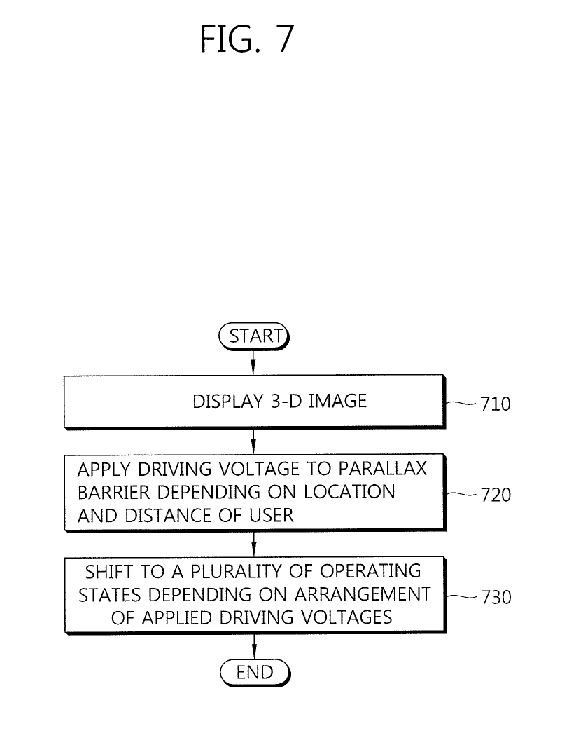

FIG. 7 is a flowchart illustrating a display method based on an SSPB in accordance with an embodiment of the present invention. A process of the display apparatus based on the parallax barrier displaying a 3-D image in accordance with the present invention is described below.

The display apparatus based on an SSPB in accordance with the present invention can play a 3-D image by displaying a left picture and a right picture in a display panel by the column at the same time at step 710. Here, the display panel can be a common display panel for playing an image by the pixel, such as a Liquid Crystal Display (LCD) panel, a Light-Emitting diode Display (LED) panel, an Organic Light-Emitting diode Display (OLED) panel, a Plasma Display Panel (PDP), or an ElectroLuminescent (EL) display panel.

When the 3-D image is played, the display apparatus based on an SSPB in accordance with the present invention can apply driving voltages to a parallax barrier depending on a location and watching distance of a user so that the user can watch the left picture and the right picture separately at step 720. Here, the parallax barrier can include liquid crystals (e.g., TN liquid crystals) placed in the front of the display panel for playing a 3-D image and configured to transmit or block light emitted from the display panel and pairs of transparent electrodes obliquely arranged to cross each other in a symmetric form in the front and rear of the liquid crystals on the basis of the liquid crystals. Here, the pairs of transparent electrodes can include a plurality of patterned ITOs, and the patterned ITOs included in the pairs of transparent electrode can be segmented into at least two groups. The wires of the transparent electrodes can be distributed over the upper and lower layers on the basis of the liquid crystals.

The display apparatus based on an SSPB in accordance with the present invention can shift the operating state of the parallax barrier by controlling an arrangement of the driving voltages applied to the transparent electrodes depending on a location and watching distance of a user so that a specific part of the 3-D image is blocked or transmitted at step 730.

Accordingly, the display apparatus based on an SSPB in accordance with the present invention can be easily fabricated due to the structure of the SSPB, can prevent crosstalk, and can provide a smooth autostereoscopic type 3-D image by shifting the SSPB to a plurality of operating states depending on a location and viewing distance of a user.

The parallax barrier includes the pairs of transparent electrodes obliquely arranged to cross each other in a symmetric form in the front and rear of the liquid crystals on the basis of the liquid crystals. Accordingly, a display can be easily fabricated, and a high-quality 3-D image without crosstalk can be provided to a user.

A smooth autostereoscopic type 3-D image can be provided by shifting the operating states of the parallax barrier by controlling an arrangement of driving voltages applied to the parallax barrier depending on a location and watching distance of a user.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the following appended claims. Accordingly, the present invention should be construed as covering all modifications or variations derived from the meaning and scope of the appended claims and their equivalents.

What is claimed is:

1. A display apparatus based on parallax barrier, comprising:
a panel configured to play a 3-D image;
a parallax barrier configured to comprise liquid crystals placed in a front of the panel and configured to transmit or block light emitted from the panel and pairs of transparent electrodes obliquely arranged to cross each other in a symmetric form in a front and rear of the liquid crystals based on the liquid crystals; and
a driving unit configured to apply driving voltages to the parallax barrier,
wherein the parallax barrier transmits or blocks a specific part of the played 3-D image through the panel in response to the applied driving voltages.

2. The display apparatus of claim 1, wherein:
the transparent electrodes comprise a plurality of patterned Indium Tin Oxides (ITOs), and
the patterned ITOs included the pairs of transparent electrodes are segmented into at least two groups.

3. The display apparatus of claim 1, wherein wires for the transparent electrode are distributed over upper and lower layers of the liquid crystals.

4. The display apparatus of claim 1, wherein the liquid crystals comprise Twisted Nematic (TN) liquid crystals.

5. The display apparatus of claim 1, wherein:
the driving unit comprises a plurality of electrodes for applying the driving voltages to the transparent electrodes, and
the driving unit controls the driving voltages applied to the transparent electrodes through the plurality of electrodes depending on a location and watching distance of a user.

6. The display apparatus of claim 1, wherein the parallax barrier shifts to a plurality of operating states depending on an arrangement of the driving voltages applied to the transparent electrodes.

7. A parallax barrier, comprising:
liquid crystals placed between an upper substrate and a lower substrate and configured to transmit or block light; and
pairs of transparent electrodes obliquely arranged to cross each other in a symmetric form in a front and rear of the liquid crystals based on the liquid crystals,
wherein the liquid crystals transmit or block the light in response to driving voltages applied to the transparent electrodes.

8. The parallax barrier of claim 7, wherein:
the transparent electrodes comprise a plurality of patterned Indium Tin Oxides (ITOs), and
the patterned ITOs included the pairs of transparent electrodes are segmented into at least two groups.

9. The parallax barrier of claim 7, wherein wires for the transparent electrode are distributed over upper and lower layers of the liquid crystals.

10. The parallax barrier of claim 7, wherein the liquid crystals comprise Twisted Nematic (TN) liquid crystals.

11. The parallax barrier of claim 7, wherein the parallax barrier shifts to a plurality of operating states depending on an arrangement of the driving voltages applied to the transparent electrodes.

12. A method of a display apparatus based on a parallax barrier displaying a 3-D image, the method comprising:
playing a 3-D image; and
applying driving voltages to the parallax barrier depending on a location and watching distance of a user,
wherein the parallax barrier comprises liquid crystals placed in a front of a panel for playing the 3-D image and configured to transmit or block light emitted from the panel and pairs of transparent electrodes obliquely arranged to cross each other in a symmetric form in a front and rear of the liquid crystals based on the liquid crystals.

13. The method of claim 12, wherein:
the transparent electrodes comprise a plurality of patterned Indium Tin Oxides (ITOs), and
the patterned ITOs included the pairs of transparent electrodes are segmented into at least two groups,

14. The method of claim 12, wherein wires for the transparent electrode are distributed over upper and lower layers of the liquid crystals.

15. The method of claim 12, wherein the liquid crystals comprise Twisted Nematic (TN) liquid crystals.

16. The method of claim 12, wherein applying the driving voltages to the parallax barrier comprises applying the driving voltages to the parallax barrier by controlling an arrangement of the driving voltages, applied to the transparent electrodes, depending on the location and watching distance of the user.

17. The method of claim 16, wherein the parallax barrier shifts to a plurality of operating states depending on an arrangement of the driving voltages applied to the transparent electrodes so that a specific part of the 3-D image is blocked or transmitted.
